(19) United States
(12) Patent Application Publication
(10) Pub. No.: US 2019/0146572 A1
(43) Pub. Date: May 16, 2019

(54) STORAGE SYSTEM WITH POWER SAVING FUNCTION

(71) Applicant: Hitachi, Ltd., Tokyo (JP)

(72) Inventors: Hidechika NAKANISHI, Tokyo (JP); Hiroshi IZUTA, Tokyo (JP)

(21) Appl. No.: 16/125,589

(22) Filed: Sep. 7, 2018

(30) Foreign Application Priority Data
Nov. 13, 2017 (JP) 2017-218306

(51) Int. Cl. G06F 1/32; G06F 1/28

(52) U.S. Cl. CPC G06F 1/3287; G06F 1/28

(57) ABSTRACT

A storage system includes one or more storage drives and a controller for controlling the one or more storage drives. Each of the one or more storage drives has a plurality of power consumption statuses. The plurality of power consumption statuses can respond to a read request and a write request, and have different power consumptions and different response performances. The controller is configured to monitor frequencies of predetermined types of I/Os to each of the one or more storage drives, and to set, based on the frequencies, each of the one or more storage drives to a status selected from the plurality of power consumption statuses.

### CLAIM OF PRIORITY

The present application claims priority from Japanese patent application JP 2017-218306 filed on Nov. 13, 2017, the content of which is hereby incorporated by reference into this application.

### BACKGROUND

This invention relates to a storage system.

Many storage systems have a power-saving function to reduce the power consumption. For example, US2008/0126702 A1 discloses a storage system configured so that a manager can perform the power saving of a desired storage apparatus through a management apparatus. The storage system has a power saving instruction reception unit that receives, from a management console, a power saving instruction specifying at least one storage apparatus among a plurality of RAID groups, a plurality of logic units, and a plurality of physical storage apparatuses; and a power saving control unit that provides the power saving of one or more physical storage apparatuses corresponding to a storage apparatus specified by the power saving instruction.

### SUMMARY

The storage system is always required to have an improved response performance. There have been more cases where the storage system is structured using a flash drive. Thus, it has been more important to assure the response performance to the storage system. Furthermore, the host I/O to the storage system changes with time. Thus, a technique has been desired to appropriately reduce the power consumption depending on the host I/O.

The storage system of one embodiment of this disclosure includes one or more storage drives and a controller for controlling the one or more storage drives. Each of the one or more storage drives has a plurality of electric power statuses. The plurality of electric power statuses can respond to I/O requests and have different power consumptions and different I/O performances. The controller monitors the I/O frequency to the one or more storage drives to set, based on the I/O frequency, the one or more storage drives to statuses selected from the plurality of electric power statuses, respectively.

According to one embodiment of this disclosure, the power consumption can be appropriately reduced depending on the host I/O.

### BRIEF DESCRIPTION OF THE DRAWINGS

FIG. 1 illustrates one example of a computer system.

FIG. 2 illustrates the layer structure of the power consumption control in the storage system.

FIG. 3 illustrates data (software) stored in the memory.

FIG. 4 illustrates a configuration example of the drive management table 145.

FIG. 5 illustrates a configuration example of the PG management table 147.

FIG. 6 illustrates the configuration example of the drive box management table.

FIG. 7A is a flowchart of the layer control of the power consumption of the parity group.

FIG. 7B is a flowchart of the control of the power consumption status of one SSD in Step S103 of the power saving layer T2.

FIG. 7C is a flowchart of the electric power consumption layer control of the drive box.

FIG. 8 is a flowchart illustrating the processing to turn ON the power supply of the drive box.

FIG. 9 is a flowchart of the processing to return the drive box controller in the power saving status to the normal status.

FIG. 10 is a flowchart to return the storage drive in the power supply OFF status to the normal status.

FIG. 11 is a flowchart of the processing to return the HDD in the spin down status to the normal status.

FIG. 12 is a flowchart of the processing to return the SSD having the core save status to the normal status.

### DETAILED DESCRIPTION OF THE EMBODIMENTS

Embodiments of this invention are described below with reference to the drawings. However, the embodiment is merely an example of how this invention is carried out, and is not to limit the technical scope of this invention. Components common to different drawings are denoted by the same reference symbols.

Because a program is executed by a processor to execute predetermined processing with the use of a memory and a communication port (communication control apparatus), the description with a program as the subject in a sentence may be read as a description having the processor as the subject. Processing disclosed with a program as the subject in a sentence may be read as processing executed by a management server (management apparatus) or a similar computer or an information processing apparatus. Some or all of programs may be implemented by dedicated hardware, or may be in the form of a module. The programs may be installed on computers via a program distribution server or a storage medium. On the other hand, the description with a processor as the subject in a sentence may be read as a description having the control program executed by the processor as the subject.

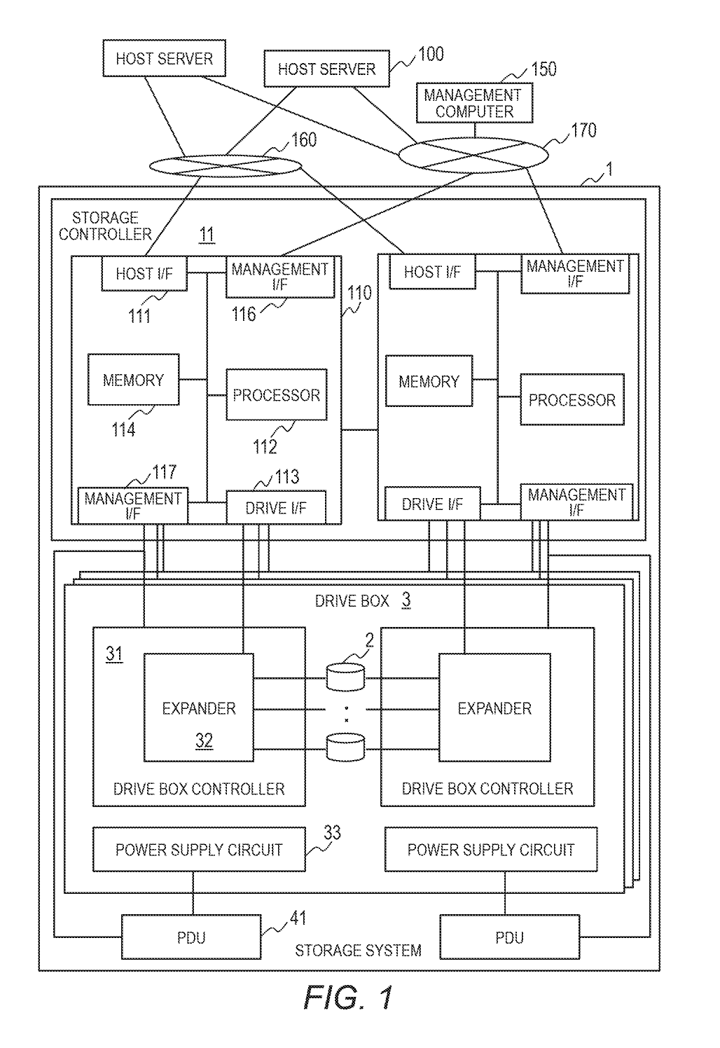

FIG. 1 illustrates one example of a computer system. In FIG. 1, the same reference numerals denoting a part of a plurality of the same type of components are omitted. The computer system includes a host server 100 mainly performing data computation, a storage system 1 storing data, and a management computer 150 managing the storage system 1 and the host server 100.

The host server 100 and the storage system 1 are connected via a data network 160. The data network 160 is a SAN (Storage Area Network) for example. The host server 100, the management computer 150, and the storage system 1 are connected via a management network 170. The management network 170 is a LAN (Local Area Network) for example. The host server 100 and the management computer 150 have a general computer configuration for example. The computer configuration includes, for example, a memory storing data, a processor operating based on a program stored in the memory, and an interface to connect to the network. The computer configuration also may further include a user input/output apparatus.

The storage system 1 includes: one or more storage drives 2; one or more drive boxes 3; and one or more PDUs (Power Distribution Units) 41 that supply electric power to the plurality of storage drives 2 and the one or more drive boxes 3. The respective drive boxes 3 store one or more storage drives 2. The storage system 1 further includes a storage controller 11 that controls, while communicating with the host server 100 and other storage systems, the one or more storage drives 2, the one or more drive boxes 3, and the one or more PDUs 41.

Each storage drive 2 is a final physical storage device for host data. Each storage drive 2 is a storage drive of an arbitrary type such as a HDD (Hard Disk Drive) or an SSD (Solid State Drive). The HDD is a magnetic disk drive. The SSD is a flash memory drive.

The respective components described below may be configured by a specific LSI (Large Scale Integration) or also may be a processor executing software. This embodiment does not limit the physical boundary between components. For example, the host server 100 and the storage system 1 may be mounted in a single physical housing.

The storage controller 11 has a redundant configuration and includes a plurality of controller packages 110. One controller package 110 also may be used. The controller package 110 includes a host interface (hereinafter referred to as host I/F) 111 communicating with the host server 100, a management I/F 116 communicating with the management computer 150, and a drive interface (hereinafter referred to as drive I/F) 113 for the communication of host data (data stored in the storage drive 2) to a drive box 3.

The controller package 110 further includes a management I/F 117 providing the communication of management data (control data) to the drive box 3 and a PDU 41. In the example of FIG. 1, the management I/F 117 is connected to only one drive box controller 31 and only one PDU 41. However, the management I/F 117 also may be connected to a plurality of drive box controllers 31 and a plurality of PDUs 41.

The controller package 110 includes a processor 112 to relay the control or data transfer of other components and a memory 114 to store data generated by the host server 100 and various pieces of data generated in the storage system 1 for control and host data. The memory 114 includes a cache memory region to temporarily store host data. The controller package 110 may include one or a plurality of component(s).

The host I/F111 converts protocol data used for the communication between the host server 100 and the storage controller 11 to protocol data used in the storage controller 11. Examples of the protocols used for the communication with the host server 100 include Fibre Channel (FC) and Internet SCSI (iSCSI). Examples of the internal protocol include PCI-Express.

The drive I/F 113 converts protocol data used for the communication between the storage drive 2 and the storage controller 11 to protocol data used within the storage controller 11. Examples of the protocol used for the communication between the storage drive 2 and the storage controller 11 include FC, Serial Attached SCSI (SAS), and NVM Express (NVMe).

The processor 112 includes a data bus to transfer data to the I/Fs 111, 113, 116, and 117 and the memory 114 and a computing circuit to execute software. The processor 112 works as a predetermined function unit by operating based on a program stored in the memory 114. As described later, the processor 112 executes, in addition to the I/O processing of the host data, the electric power control of the storage drive 2 and the drive box 3. Other LSIs also may be used in addition to the processor 112.

The memory 114 is constituted by storage elements that can be accessed at a high speed such as DRAM. The memory 114 is connected to the processor 112 via a memory interface such as DDR 3 or DDR 4. The memory 114 also may be configured by a plurality of memory modules. The memory 114 includes a cache memory region to temporarily store host data (I/O target data) to the storage drive and a common memory region to store various pieces of management information of the storage system 1. The cache memory region and the common memory region include the data which is made redundant in the cache memory region and the common memory region in the memory 114 in a plurality of controller packages 110 in preparation for a failure. The memory 114 further includes a temporary storage region to store non-redundant data.

The storage controller 11 is connected to a plurality of storage drives 2 via a drive I/F 113 to constitute RAID (Redundant Arrays of Inexpensive Disks). In this disclosure, a group of the storage drives 2 including RAID to store the redundant data and the host data is referred to as a redundancy group or a parity group (PG). The storage controller 11 allows storage regions of an arbitrary number of storage drives 2 (parity groups) to be accessed as one volume from the host server 100.

When the storage controller 11 receives, from the host server 100, a write request to a volume, the storage controller 11 generates parity data (redundant data) depending on the RAID configuration to write host data and parity data to different storage drives 2. When the storage controller 11 receives, from the host server 100, a read request to a volume, then the storage controller 11 tries to read the request data from the storage drive 2 to subsequently investigate whether the data is lost. When the data loss is detected, the storage controller 11 uses other pieces of host data and parity data of RAID to restore the request data to transfer the restored request data to the host server 100. This function improves the reliability, availability, and I/O performance.

The storage controller 11 forms one parity group configured by a plurality of (or four) storage drives 2 for example. When data in one storage drive 2 cannot be accessed due to a failure therein, the storage controller 11 uses data stored in the remaining storage drives 2 in the same parity group to restore the data stored in the storage drive 2 having the failure.

In order to process the I/O request (the read request or write request) from the host server 100, the storage controller 11 manages the correspondence between the address space of the volume and the address space of the storage drive 2 based on a not-shown volume management table. The I/O request from the host server 100 also may be referred to as a host access.

The storage controller 11 divides the address space of the volume into a plurality of storage regions having a fixed size to associate the respective storage regions to the storage regions in the parity group. The storage regions in the parity group are identified by the identifiers of the storage drive 2 and the logic addresses in the storage drive. How to manage the correspondence between the volume and the storage drive 2 is a well-known technique and thus will not be described further.

The storage system 1 includes one or a plurality of the drive box(es) 3. The drive box 3 may be omitted. The drive box 3 includes a plurality of slots (not shown in FIG. 1) each of which stores one storage drive 2, one or more drive box controller(s) 31, and one or more power supply circuit(s) 33. The drive box 3 stores one or more storage drives 2.

In the example of FIG. 1, one drive box 3 provides redundancy by including therein two drive box controllers 31 and two power supply circuits 33. The drive box controllers 31 and the power supply circuits 33 may be provided in an arbitrary number, respectively.

In the example of FIG. 1, the power supply circuits 33 receive the electric power from different PDUs 41, respectively. The respective power supply circuits 33 may be connected to two PDUs 41 so as to receive the electric power from two PDUs 41. The two power supply circuits 33 supply the electric power to all of the drive box controllers 31 or storage drives 2. The drive box controllers 31 and the storage drives 2 are connected to both power supply circuits 33 so as to be able to receive the electric power from any of the power supply circuits 33.

For example, one power supply circuit 33 supplies electric power to one drive box controller 31 and a part of the storage drives 2 and the other power supply circuit 33 supplies electric power to the other drive box controller 31 and the remaining storage drive 2. The one power supply circuit 33 may operates in a normal status and the other power supply circuit 33 may be in a stand-by status.

The drive box controller 31 provides the transfer of a request (command) and host data between the storage controller 11 and the storage drives 2 stored in the drive box 3. The drive box controller 31 controls the ON/OFF (power consumption) of the power supply of the storage drive 2. The drive box controller 31 controls the power consumption of the drive box 3 depending on an instruction from the storage controller 11.

The drive box controller 31 includes an expander 32. The expander 32 includes a switch and transfers data (including a request and host data) from the storage controller 11 to the storage drive 2 as a destination and transfers data from the storage drive 2 to the storage controller 11. The expander 32 can communicate with a plurality of storage drives 2 via one port of the storage controller 11. The storage drive 2 is identified by the drive box number (R number) and the slot number (C number) in the drive box for example.

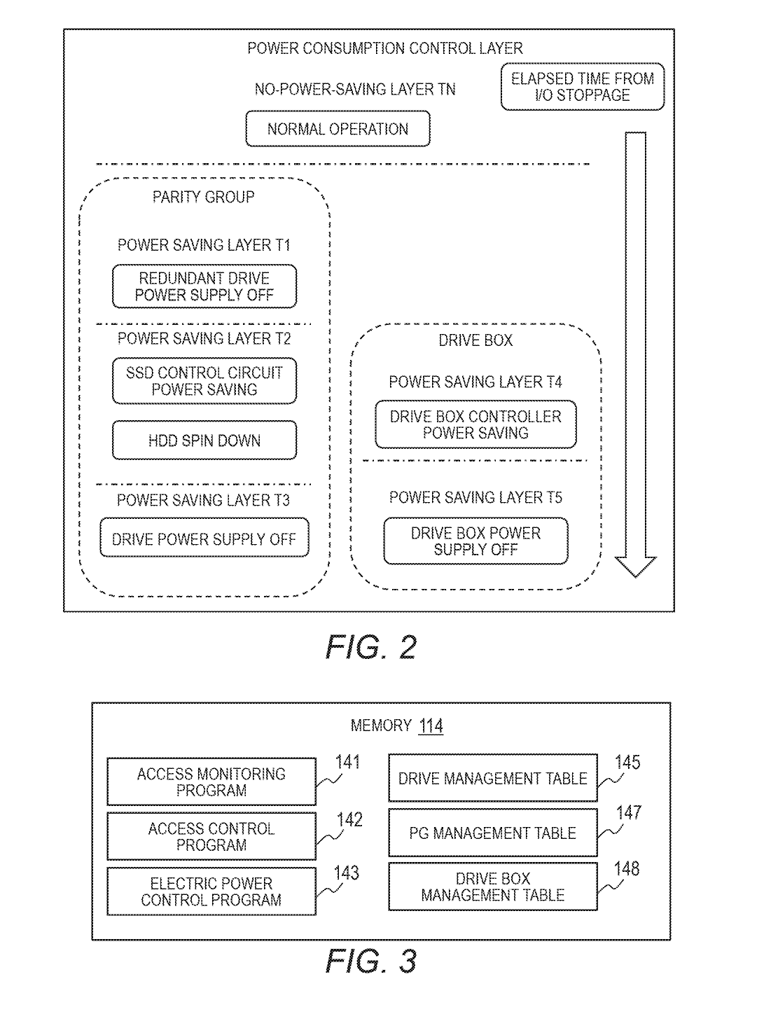

FIG. 2 illustrates the layer structure of the power consumption control in the storage system 1. In FIG. 2, the exemplary layer structure includes a power consumption control layer structure of one parity group consisting of a plurality of storage drive 2 and the power consumption control layer structure of one drive box 3 storing one or a plurality of storage drive(s) 2.

The layer structure includes no-power-saving layer TN to allow the parity group or the drive box 3 to normally operate under normally-supplied electric power and a plurality of power saving layers to provide power consumption smaller than that in the normal status with a different control method. The parity group or the drive box 3 in each layer has a status corresponding to the layer. The example of the layer structure shown in FIG. 2 has, in addition to the no-power-saving layer TN, three power saving layers T1, T2, and T3 of the parity group and two power saving layers T4 and T5 of the drive box 3.

The power saving layers T1, T2, and T3 have a higher power saving effect in this order. Specifically, the parity group has a smaller power consumption. On the other hand, the time required for the recovery from the power saving layer to the no-power-saving layer is basically longer when the layer has a larger depth. The storage system 1 uses the power saving layer T1, the power saving layer T2, and the power saving layer T3 in a stepwise manner depending on the time since the stoppage of a predetermined type of the host I/O to the parity group. This can consequently reduce the response delay while providing a higher power saving effect. In an example described later, the predetermined type of the host I/O referred to during the shift from the no-power-saving layer TN to the power saving layer T1 is a write access only. The predetermined type of the host I/O referred to during other shifts to other layers having a higher power saving effect include a write access and a read access.

In the power saving layers T4 and T5, the drive box 3 stores the storage drive 2 having a power supply turned to OFF. The power saving layer T5 has a higher power saving effect than that of the power saving layer T4. The power consumption of the drive box 3 is lower in the power saving layer T5 than in the power saving layer T4. The time required for the recovery to the no-power-saving layer is longer in the power saving layer T5.

The storage system 1 determines the shift from the power saving layer T4 to the power saving layer T5 based on the I/O-stopped time (the time during which no I/O exists) from the shift to the power saving layer T4 to (the storage drive 2 in) the drive box 3. This can consequently reduce the response delay while improving the power saving effect. The combination of the electric power control of the parity group and the control of the electric power of the drive box 3 can improve the power saving effect of the storage system 1. The time required from the OFF status of the power supplies of the drive box 3 and the storage drive 2 to the recovery is longer than the time required for the recovery from the OFF status of the power supplies of all of the stored storage drives 2 in which the drive box 3 normally operates.

The following section will describe the power consumption control layer structure shown in FIG. 2 from the view point of one parity group and one drive box 3. The drive box 3 may store one or all of the storage drives 2 of the parity group or may store no storage drives 2 of the parity group.

In the no-power-saving layer TN, all of the storage drives 2 and the drive box 3 of the parity group operate under normally-supplied electric power. In the first power saving layer T1 of the parity group, the storage controller 11 turns OFF the power supply of a part of the storage drives 2 in the parity group. Specifically, as described later, the storage controller 11 turns OFF the power supplies of the storage drive 2 in the upper limit redundancy number within the parity group. In the parity group having this status, the power consumption is lower than that in the normal status.

In the configuration example described below, one parity group is configured by the same type of the storage drives 2. For example, one parity group is composed of a plurality of HDDs or is composed of a plurality of SSDs. In this disclosure, the power saving status is a status in which the power consumption is smaller than that in the normal status.

In the power saving layer T1, when the storage controller 11 receives a read request to the storage drive 2 having the ON power supply, the storage controller 11 reads data from the storage drive 2. When the storage controller 11 receives the read request from the storage drive 2 having the OFF power supply, the storage controller 11 collects data from other storage drives 2 having the ON power supply to restore the target data of the read request (which is called as a collection read). This can consequently reduce the delay of the response to the read request.

When the storage controller 11 receives the write access to the parity group, the storage controller 11 turns ON the power supply of the storage drive 2 having the OFF power supply and returns to the no-power-saving layer TN. The storage controller 11 writes host data and redundant data to the corresponding storage drives 2, respectively. In the next power saving layer T2 of the parity group, the storage controller 11 causes an HDD having an ON power supply in a parity group consisting of HDDs to change to a spin down status. The spin down status is a status in which the rotation of a magnetic disk is stopped and the HDD cannot process an I/O request and can process a control command only. In an example describer later, the storage controller 11 causes the HDD to change to the spin down status when there is no write access and read access to the parity group over a specified time.

In the power saving layer T2, the storage controller 11 causes an SSD having an ON power supply in a parity group consisting of SSDs to have a control circuit a part of which is changed to the sleep status. In this disclosure, this status of the SSD is called a core save status. In the core save status, the power consumption is lower than that in the normal status and is higher than that in the power supply OFF status. The SSD in the core save status can process and respond to not only the control command but also the read request and the write request (I/O request). Since the operation of a part of the control circuit is stopped, the SSD in the core save status has a lower maximum I/O performance (maximum response performance). In an example described later, the SSD has a plurality of core save statuses having different power saving effects (or power consumptions).

In an example described later, the storage controller 11 causes, depending on the I/O frequency (or specifically the read frequency) to the SSD, the power consumption status of the SSD to change among one or more core save statuses and normal statuses. As the I/O frequency decreases, the storage controller 11 causes the SSD to change to a status having a smaller power consumption. This can consequently more appropriately reduce, depending on the I/O to the storage drive, the power consumption while reducing the response delay.

The storage controller 11 switches the status of the SSD of the parity group having the ON power supply between statuses having different power consumptions in which a response to the I/O request is possible. The SSD of the parity group having the ON power supply is in a status to be subjected to this control. Since the SSD may be in the core save status, the SSD and the parity group require smaller power consumption than that in the power saving layer T1.

In the power saving layer T3 next to the parity group, the storage controller 11 turns OFF the power supplies of all of the storage drives 2 of the parity group. During the shift from the power saving layer T2 to the power saving layer T3, the power supply of the storage drive 2 is switched from ON to OFF. Since the power supplies of all of the storage drives 2 of the parity group is OFF, this parity group requires the minimum power consumption.

Next, the following section will describe the power consumption control layer structure of the drive box 3. In the power saving layer T4 of the drive box 3, the storage controller 11 causes all of the drive box controllers 31 of the drive box 3 to have the power saving status. In one example of the power saving status of the drive box controller 31, in a sleep status in which the expander 32 is in the sleep status, the operation of the expander 32 is stopped (or temporarily stopped), failing to be able to accept commands other than a command for a SAS connection request.

In an example described later, the shift to the power saving layer T4 requires conditions that all of the storage drives 2 (or all parity groups) stored in the drive box 3 have OFF power supplies. In the power saving layer T5 next to the drive box 3, the storage controller 11 turns OFF the power supply of the drive box 3. In the power saving layer T5, the drive box 3 and all of the storage drives 2 stored therein have OFF power supplies. In an example described later, the storage controller 11 is configured, when a specified time has passed since the power supplies of all of the storage drives in the drive box 3 are turned OFF, to turn OFF the power supply of the drive box 3.

Turning OFF the power supply of the storage drive 2 requires conditions that the specified time has passed since the host I/O is stopped (or a write access is stopped or write and read accesses are stopped) as described above. Thus, the power consumption control of the drive box 3 is shifted in a stepwise manner among layers depending on the time elapsed since the stoppage of the host I/O. When all of the storage drives 2 of one parity group are stored in one drive box 3, the drive box 3 has the power saving layer T4 next to the power saving layer T3 of the parity group. When only a part of the storage drives 2 of one parity group is stored in the drive box 3, the shift to the power saving layer T2 of the parity group may be followed by the shift to the power saving layer T4 of the drive box 3.

FIG. 3 illustrates data (software) stored in the memory 114. The memory 114 stores therein an access monitoring program 141, an access control program 142, and an electric power control program 143. The memory 114 further stores therein a drive management table 145, a PG management table 147, and a drive box management table 148.

The programs 141, 142, and 143 shown in FIG. 3 are stored in the controller packages 110, respectively. The information of the tables 145, 147, and 148 are shared among the controller packages 110. One controller package 110 includes the tables 145, 147, and 148 that are updated so that the updated details are reflected on the tables 145, 147, and 148 of the other controller packages. The processor 112 functions as an access monitoring unit, an access control unit, and an electric power control unit by operating based on the access monitoring program 141, the access control program 142, and the electric power control program 143, respectively.

The access monitoring program 141 monitors the access (I/O request) from the host server 100 to each storage drive 2. The access control program 142 controls the I/O request (host access) from the host server 100 to the storage drive 2. The electric power control program 143 controls the power consumption of the storage drive 2 and the drive box 3.

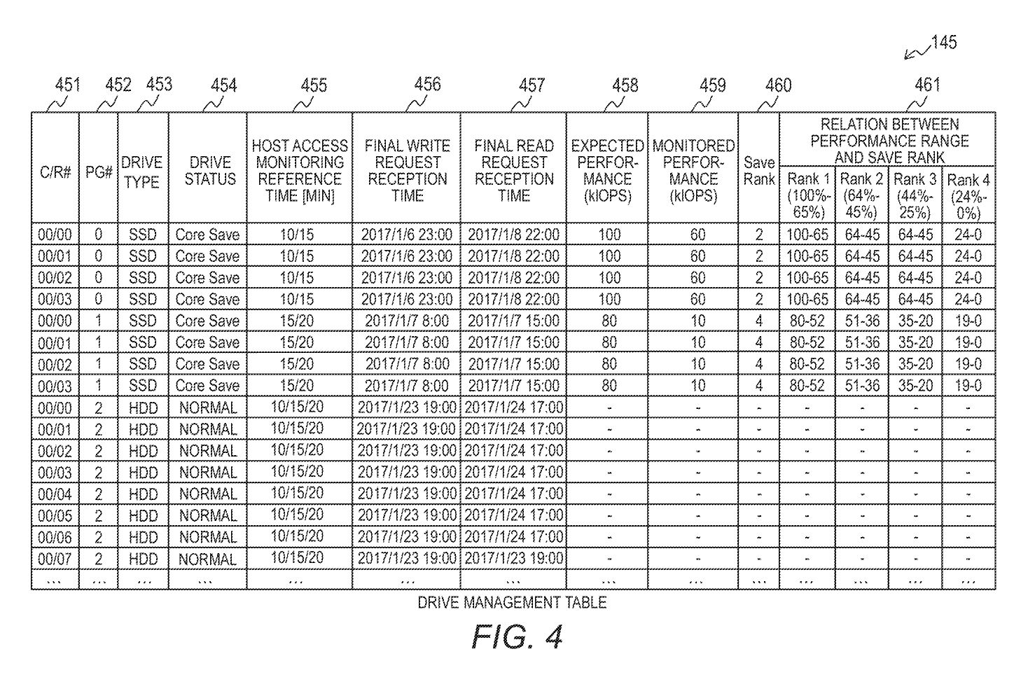

FIG. 4 illustrates a configuration example of the drive management table 145. The drive management table 145 manages the information of the storage drive 2 and retains information regarding the parity group to which the storage drive 2 belongs, the electric power status of the storage drive 2, the performance of the storage drive 2, and an access to the storage drive 2 for example. The drive management table 145 includes a C/R# column 451, a PG# column 452, a drive type column 453, a drive status column 454, a host access monitoring reference time column 455, a last write request reception time column 456, a last read request reception time column 457, an expected performance column 458, a monitored performance column 459, a save rank column 460, and a column 461 showing the relation between the performance range and the save rank.

The C/R# column 451 represents the identifier (R number) of the drive box 3 storing therein the storage drive 2 and the slot identifier (C number). The PG# column 452 represents the identifier of the parity group to which the storage drive 2 belongs. The drive type column 453 represents the type of the storage drive 2.

The drive status column 454 shows the current status of the storage drive 2. Specifically, the drive status column 454 shows the status of the storage drive 2. The drive status column 454 shows the information of the power consumption control layer (power consumption control status) of the storage drive 2. The status of the storage drive 2 includes, for example, a normal status, a core save status (SSD), a spin down status (HDD), and a power supply OFF status.

The normal status, the spin down status, and the power supply OFF status show the power consumption status of the storage drive 2, respectively. The core save status shows that the SSD is under a switch control (power saving layer T2) among a plurality of statuses including the core save status.

The host access monitoring reference time column 455 shows the reference time during which the status of the electric power consumption of the storage drive 2 is changed. In this example, two monitoring reference times are set to SSD and three monitoring reference times are set to HDD.

The first monitoring reference time to SSD is a reference time in the layer configuration described with reference to FIG. 2 during the shift from the no-power-saving layer TN to the first power saving layer T1. The second monitoring reference time to SSD is a reference time in the layer configuration described with reference to FIG. 2 during the shift from the power saving layer T2 to the power saving layer T3.

As described later, the first monitoring reference time is compared with the elapsed time since the last write access time to the parity group. The second monitoring reference time is compared with the elapsed time since the later one among the last write access and the last read access to the parity group. The access time is the time at which the host I/O request is received by the storage controller 11 for example.

The first monitoring reference time to HDD is the reference time of the shift from the no-power-saving layer TN to the power saving layer T1 in the layer configuration described with reference to FIG. 2. The second monitoring reference time to HDD is the reference time of the shift from the power saving layer T1 to the power saving layer T2. The third monitoring reference time to HDD is the reference time of the shift from the power saving layer T2 to the power saving layer T3.

As described later, the first reference time is compared with the elapsed time since the last write access time to the parity group. The second and third reference times are compared with the elapsed time elapsed since the later one among the last write access and the last read access to the parity group, respectively.

The last write request reception time column 456 shows the reception time (write access time) of the last write request to the parity group. The last read request reception time column 457 shows the reception time (read access time) of the last read request to the parity group.

The expected performance column 458 shows the specification performance of the storage drive 2 that is expected in the normal status. The monitored performance column 459 shows the monitor value of the current performance of the storage drive 2. In this example, the SSD performance is monitored while the HDD performance is not monitored.

The save rank column 460 shows the ranks (save ranks) allocated to the normal status and the core save status of the SSD. The save rank column 460 is referred to in the power saving layer T2. The SSD has a plurality of statuses having different power consumption and maximum performance to which different save ranks are given. The relation column 461 for the performance range and the save rank shows the relation between the monitor value of the current performance of the SSD (the value of the monitored performance column 459) and a save rank to which the SSD should be set.

In the example of FIG. 4, the rank 1 is the lowest save rank and the rank 4 is the highest save rank. The higher the save rank is, the higher the power saving effect is and the lower the maximum performance is. In the example of FIG. 4, the rank 1 is the save rank for the normal status in which the SSD can provide the 100% maximum performance based on the specification.

As described later, the electric power control program 143 updates the values of the drive status column 454 and the save rank column 460. The access monitoring program 141 monitors the I/O to each storage drive 2 to update, as required, the values of the last write request reception time column 456, the last read request reception time column 457, and the monitored performance column 459. The other columns of the drive management table 145 have values set in advance.

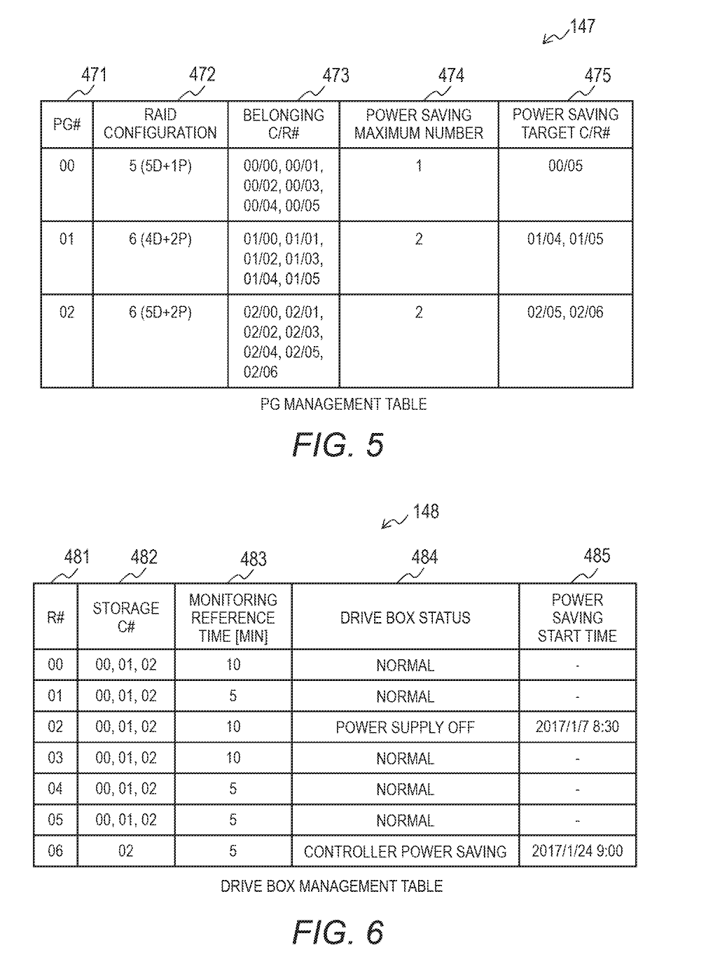

FIG. 5 illustrates a configuration example of the PG management table 147. The PG management table 147 manages the information of the parity group. Specifically, the PG management table 147 includes the storage drive constituting the parity group and the information for the power saving setting of the parity group. The PG management table 147 includes a PG# column 471, a RAID configuration column 472, a belonging C/R# column 473, a power saving maximum number column 474, and a power saving target C/R# column 475. These values are set in advance.

The PG# column 471 shows the identifier of the parity group. The RAID configuration column 472 shows the RAID configuration of the parity group (the example of the redundant configuration). The RAID configuration is defined by the RAID level, the number of data drives, and the number of parity drives. The belonging C/R# column 473 shows the identifier (R number) of the drive box storing the storage drive 2 belonging to the parity group and the slot identifier (C number).

The power saving maximum number column 464 shows the number of the storage drive(s) 2 that are/is permitted to be set to the power saving status in the parity group. This value is selected from among values equal to or lower than that of the redundancy of the parity group (the number of parity drives). This can consequently restore data stored in a storage drive in the power saving status by the collection read. In this example, the power saving maximum number column 475 corresponds to the power saving status of the parity group. This can consequently improve the power saving effect.

The power saving target C/R# column 476 shows the C number and the R number of the storage drive 2 changed to the power saving status in the parity group. The number of values shown by the power saving target C/R# column 476 correspond to the value shown by the power saving maximum number column 475.

FIG. 6 illustrates the configuration example of the drive box management table 148. The drive box management table 148 manages the information of the drive box 3. Specifically, the drive box management table 148 manages the information for the storage drive 2 stored in the drive box 3 and information referred to for the control of the power consumption of the drive box 3. The drive box management table 148 includes an R# column 481, a storage C# column 482, a monitoring reference time column 483, a drive box status column 484, and a power saving start time column 485. These values are values set in advance.

The R# column 471 shows the R number of the drive box 3. The storage C# column 472 shows the C numbers of the storage drives 2 stored in the drive box 3, respectively. The monitoring reference time column 483 shows the reference time required for the shift from the power saving layer T4 to the power saving layer T5. In this example, the monitoring reference time column 483 is compared with elapsed time since the drive box controller 31 of the drive box 3 is set to the power saving status.

The drive box status column 484 shows the power consumption status of the drive box 3. The power consumption statuses of the drive box 3 include the normal status, the power saving status in which the drive box controller 31 is in the sleep status, and the power supply OFF status. The power saving start time column 485 shows the time at which the drive box controller 31 changes to the sleep status. This corresponds to the time at which the power supplies of the all storage drives 2 stored in the drive box 3 are turned OFF.

The following section will describe the power consumption layer control of the parity group and the drive box 3. As has been described with reference to FIG. 2, the storage controller 11 causes, in a stepwise manner, the respective power consumption statuses of the parity group and the drive box 3 to change to a status requiring less power consumption.

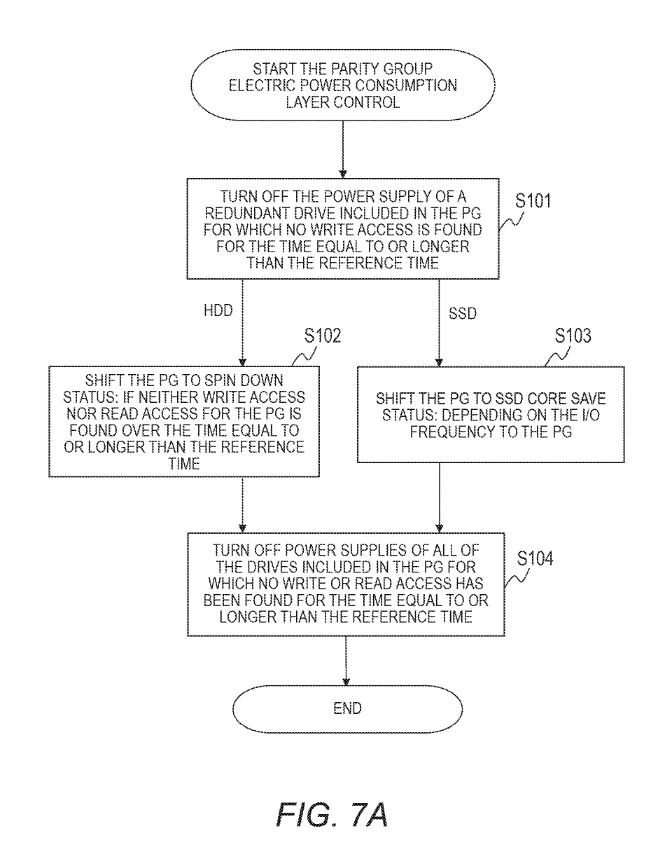

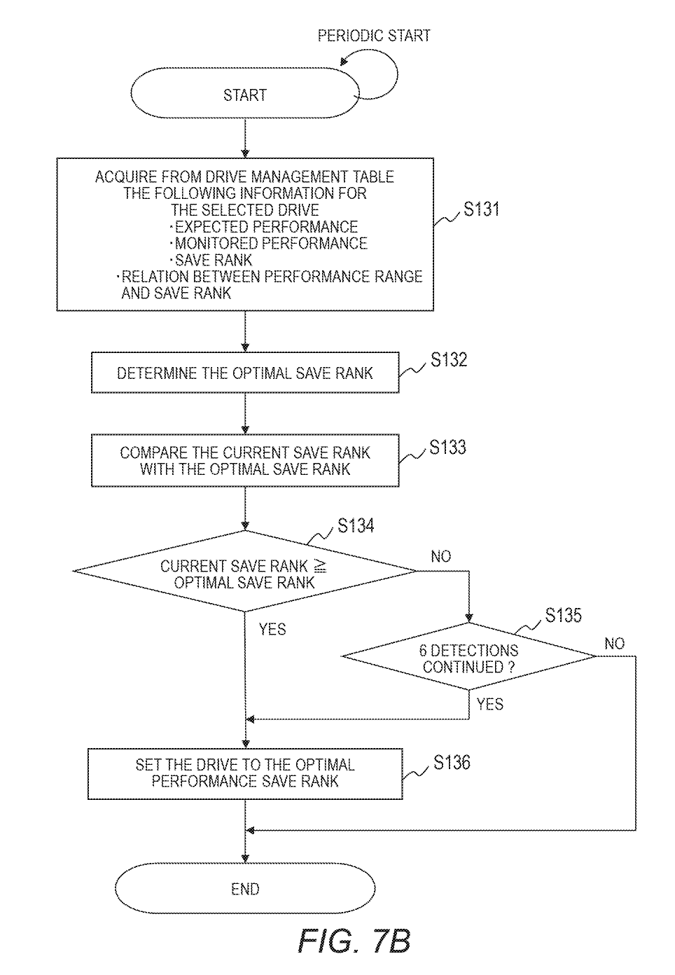

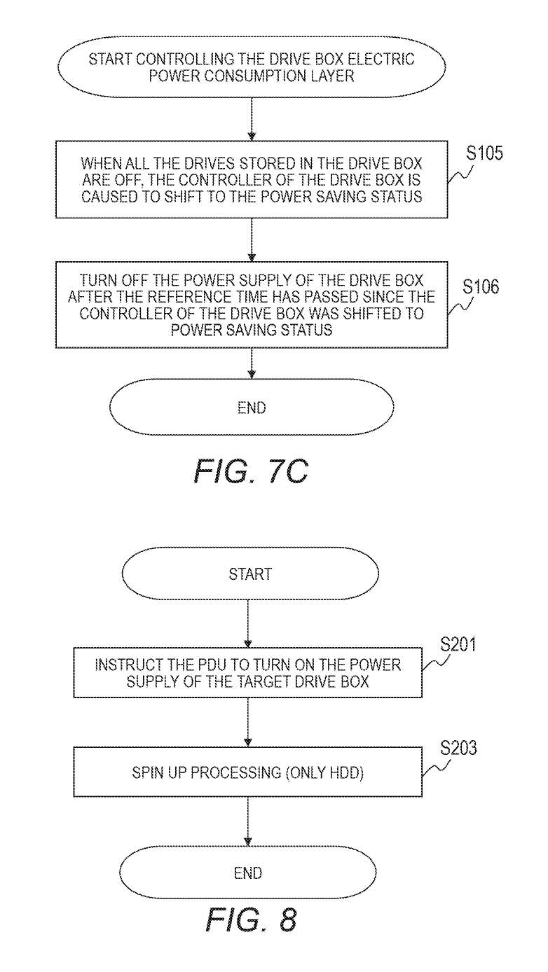

FIG. 7A is a flowchart of the layer control of the power consumption of the parity group. The electric power control program 143 is configured, when the elapsed time since the last write access to the parity group in the no-power-saving layer TN is equal to or longer than the reference time, to turn OFF the power supplies of the storage drives (redundant drives) 2 equal to or lower than the redundancy in the parity group (S101).

Specifically, the electric power control program 143 refers to the drive status column 454 of the drive management table 145 to identify the power consumption control layer of the parity group. When the drive status column 454 shows the “normal status” to the storage drives 2 of the parity group, it means that the parity group is in the no-power-saving layer TN.

The electric power control program 143 acquires the latest time from the last write request reception time column 456 in the parity group. The electric power control program 143 further acquires the first monitoring reference time from the host access monitoring reference time column 455.

When the time from the last write request reception time to the current time is equal to or longer than the first monitoring reference time, then the electric power control program 143 determines that the power consumption control layer of the parity group is shifted from the no-power-saving layer TN to the first power saving layer T1. The electric power control program 143 refers to the PG management table 147 to acquire, from the power saving target C/R# column 475, the identifier of the storage drive 2 to turn OFF the power supply in the parity group.

The electric power control program 143 specifies the acquired identifier to send a command to turn OFF the power supply of the storage drive 2 to the drive box controller 31 via the management I/F 117. Then, the drive box controller 31 sends a signal to the power supply control line of the specified storage drive 2 to turn OFF the power supply.

The electric power control program 143 changes the value of the storage drive 2 at which the power supply in the drive status column 454 of the drive management table 145 is turned OFF from “normal” to “power supply OFF”.

Conditions required for the shift from the power saving layer T1 to the power saving layer T2 and the control of the storage drive 2 in the power saving layer T2 are different between HDD and SSD. When the parity group is configured by HDD, the control in the power saving layer T2 changes the HDD in the normal status to the spin down status.

When the parity group is configured by SSD, the control in the power saving layer T2 is performed by controlling the electric power consumption of the SSD having the power supply ON in a status in which an I/O request can be responded. In this example, depending on the read access frequency, the SSD power consumption status is changed between a plurality of core save statuses and the normal status.

First, the following section will describe the control of a parity group consisting of HDD. When the parity group is configured by HDD and the parity group does not receive a write access or a read access for the time equal to or longer than the reference time, the electric power control program 143 causes the storage drive 2 in the normal status in the parity group to shift to the spin down status (S102).

Specifically, the electric power control program 143 refers to the drive management table 145. When the drive type column 453 shows “HDD” and the drive status column 454 shows “power supply OFF” to a part of the storage drives 2 in the parity group and shows “normal” to other storage drives 2, it is determined that the parity group is configured by HDD and exists in the first power saving layer T1.

The electric power control program 143 acquires the latest time in the last write request reception time column 456 and the last read request reception time column 457 in the parity group. The electric power control program 143 further acquires the second monitoring reference time from the host access monitoring reference time column 455.

When the time from the latest time to the current time is equal to or longer than the second monitoring reference time, the electric power control program 143 determines that the power consumption layer of the parity group is shifted from the first power saving layer T1 to the second power saving layer T2.

The electric power control program 143 acquires the C/R# of the storage drive 2 in the parity group for which the drive status column 454 shows “normal status”. The electric power control program 143 sends, to the expander 32 (drive box controller 31), a command to instruct that the C/R# of the storage drive (HDD) 2 is specified via the drive I/F 113 to change it to the spin down status.

The expander 32 sends, to the specified storage drive (HDD) 2, a command to instruct to change the normal status to the spin down status in a line for I/O. Based on the command, the storage drive (HDD) 2 stops the rotation of the magnetic disk.

The electric power control program 143 changes the value of the storage drive 2 set to the spin down status in the drive status column 454 of the drive management table 145 from “normal” to “spin down”.

Next, the following section will describe the power consumption control of a parity group consisting of SSD. When the parity group is configured by SSD, the electric power control program 143 controls, in the parity group, the power consumption of the SSD having an ON power supply in a status in which an I/O request can be processed (S103).

In this example, the electric power control program 143 shifts to the power saving layer T2 immediately after the shift to the power saving layer T1. Specifically, the electric power control program 143 turns OFF the power supply of a part of the SSDs immediately after which the electric power control program 143 starts the power consumption control in a status in which I/O requests from other SSDs can be processed.

The electric power control program 143 refers to the drive management table 145 to determine, when the drive type column 453 shows “SSD” and the drive status column 454 shows “power supply OFF” to a part of the storage drives 2 in the parity group and shows “normal” to other storage drives, that the parity group is configured by SSD and exists in the power saving layer T1.

The electric power control program 143 changes, in the drive management table 145, the value of the drive status column 454 of the storage drive 2 for which the parity group has an ON power supply from “normal” to “core save”.

The electric power control program 143 also may be configured, when a specified time has passed since the shift to the first power saving layer T1, to start the control of the second power saving layer T2. For example, when the specified time has passed since the stoppage of the write access from the host server 100, the electric power control program 143 may start the power consumption control of the SSD in a status in which an I/O request can be responded. This specified time is longer than the specified time required for the shift from the no-power-saving layer TN to the power saving layer T1.

FIG. 7B is a flowchart of the control of the power consumption status of one SSD in Step S103 of the power saving layer T2. Specifically, FIG. 7B shows the flowchart of the control of the SSD in the “core save” status. The electric power control program 143 sequentially selects, from the drive management table 145, the storage drive (SSD) for which the drive status column 454 shows the “core save” to execute the processing of FIG. 7B. The electric power control program 143 performs the processing shown in FIG. 7B on each target SSD in a periodic manner (e.g., at every 10 seconds).

First, the electric power control program 143 selects, from the drive management table 145, the storage drive (SSD) for which the drive status column 454 shows “core save” to acquire required information (S131). Specifically, the electric power control program 143 acquires the information for the selected storage drive from the expected performance column 458, the monitored performance column 459, the save rank column 460, and the relation column 461 of performance ranges and save ranks.

The electric power control program 143 determines the optimal save rank for the storage drive based on the values shown by the monitored performance column 459 and the relation column 461 of the performance ranges and the save ranks (S132). As described later, when a write access to a parity group occurs in the power saving layer T2, then the parity group returns to the normal status. Thus, the I/O frequency shown by the monitored performance column 459 is a read access frequency.

The electric power control program 143 compares the determined optimal save rank with the current save rank shown by the save rank column 460 (S133). As described above, an increase of the save rank causes a lower performance and a higher power saving effect. When the current save rank is lower than the optimal save rank (or when the current maximum performance is higher than the optimal maximum performance) (S134:NO), then the electric power control program 143 determines whether similar determinations continued for a prescribed number (6 times in this example) (S135).

When the determination that the current save rank is lower than the optimal save rank (S134:NO) did not continue 6 times (S135:NO), the electric power control program 143 completes this processing flow.

When the above determination continued 6 times (S135:YES), then the electric power control program 143 sets the save rank of the storage drive 2 to the optimal save rank (S136). When the current save rank is equal to or higher than the optimal save rank (or when the current maximum performance is equal to or lower than the optimal maximum performance) (S134:NO), then the electric power control program 143 sets the save rank of the storage drive 2 to the optimal save rank (S136).

Returning to FIG. 7A, the electric power control program 143 is configured, in the power consumption control layer structure of the parity group, to shift to the power saving layer T2 to subsequently shift to the power saving layer T3 (S104). When a write access and a read access to the parity group do not exist for the time equal to or longer than the reference time, the electric power control program 143 switches the power supply of the storage drive 2 from ON to OFF in the parity group.

The specific processing in Step S104 is different between the parity group of the HDD and the parity group of the SSD. First, the following section will describe the processing of the parity group of the HDD. In the power saving layer T2, the parity group of the HDD is identified based on the drive management table 145 in the manner as described below.

The drive type column 453 shows “HDD” to all of the storage drives 2 of the parity group. The drive status column 454 shows “power supply OFF” to a part of the storage drives 2 within the parity group and shows “spin down” to other storage drives.

The electric power control program 143 is configured to acquire, in the last write request reception time column 456 and the last read request reception time column 457, the latest time in the parity group. The electric power control program 143 further acquires the third monitoring reference time from the host access monitoring reference time column 455.

When the time from the above latest time to the current time is longer than the third monitoring reference time, then the electric power control program 143 determines the shift from the power saving layer T2 to the power saving layer T3 for the power consumption control of the parity group.

The electric power control program 143 acquires, from the parity group, the C/R# of the storage drive 2 for which the drive status column 454 shows “spin down”. The electric power control program 143 specifies the acquired identifier to send a command to turn OFF the power supply of the storage drive 2 to the drive box controller 31 via the management I/F 117.

The drive box controller 31 sends a signal to the power supply control line of the specified storage drive 2 to turn the power supply OFF. The electric power control program 143 changes the value of the storage drive 2 for which the power supply in the drive status column 454 of the drive management table 145 is turned OFF from “spin down” to “power supply OFF”.

Next, the following section will describe the processing of the parity group of the SSD in Step S104. In the power saving layer T2, the parity group of the HDD is identified based on the drive management table 145 in the manner described below. The drive type column 453 shows “SSD” to all of the storage drives 2 of the parity group. The drive status column 454 shows “power supply OFF” to a part of the storage drives 2 within the parity group and shows “core save” to other storage drives 2.

The electric power control program 143 acquires the latest time in the parity group in the last write request reception time column 456 and the last read request reception time column 457. The electric power control program 143 further acquires the second monitoring reference time from the host access monitoring reference time column 455.

When the time from the above latest time to the current time is equal to or longer than the second monitoring reference time, the electric power control program 143 determines the shift from the second power saving layer T2 to the third power saving layer T3 for the power consumption control of the parity group.

The electric power control program 143 acquires the C/R# of the storage drive 2 for which the drive status column 454 shows “core save” in the parity group. The electric power control program 143 specifies the acquired identifier and sends a command to turn OFF the power supply of the storage drive 2 to the drive box controller 31 via the management I/F 117.

The drive box controller 31 sends a signal to the power supply control line of the specified storage drive 2 to turn OFF the power supply. The electric power control program 143 changes the value of the storage drive 2 for which the power supply in the drive status column 454 of the drive management table 145 is OFF from “core save” to “power supply OFF”.

Next, the following section will describe the power consumption control of the drive box 3. FIG. 7C is a flowchart of the electric power consumption layer control of the drive box 3. When predetermined conditions are satisfied, the electric power control program 143 shifts to the power saving layer T4 for the power consumption control of the drive box 3. Specifically, the electric power control program 143 is configured, when the power supplies of all of the storage drives 2 stored in the drive box 3 are OFF, to shift the drive box 3 from the normal status to the power saving status (S105).

Specifically, the electric power control program 143 refers to the drive box management table 148 and the drive management table 145 to identify the drive box 3 for which the value of the drive box status column 484 shows “normal” and the values of the drive status columns 454 of all of the storage drives 2 stored therein are “power supply OFF”.

The electric power control program 143 instructs the drive I/F 113 to cut off the link between the drive box 3 and the drive I/F 113. In the configuration example of FIG. 1, different controller packages 110 for example cut off the corresponding links between the drive box controllers 31 and the drives I/F 113.

When the link between the drive box controller 31 and the drive I/F 113 is cut off, then the drive box controller 31 causes the expander 32 to shift from the normal status to the sleep status. In this manner, the drive box controller 31 is caused to shift from the normal status to the power saving status. The electric power control program 143 may send a command to change the drive box controller 31 from the normal status to the power saving status to the drive box controller 31 via the management I/F 117.

The electric power control program 143 in the drive box management table 148 changes the value of the drive box status column 484 of the drive box 3 from “normal” to “controller power saving”. The electric power control program 143 further updates the value of the power saving start time column 485 of the drive box 3 to the time at which the drive box 3 was changed to the power saving status.

The electric power control program 143 causes the parity group and the power consumption status of the drive box 3 storing therein the parity group to shift to the power saving layer T4 to subsequently shift to the power saving layer T5 (S106). The electric power control program 143 turns OFF the power supply of the drive box 3 when a predetermined time has passed since the drive box controller 31 is turned to the power saving status.

Specifically, the electric power control program 143 refers to the drive box management table 148 to identify the drive box 3 for which the drive box status column 484 shows the “controller power saving”. The electric power control program 143 acquires the monitoring reference time from the monitoring reference time column 483 of the drive box 3 to compare the monitoring reference time with the elapsed time from the power saving start time column 485. When the elapsed time is equal to or longer than the monitoring reference time, the electric power control program 143 determines that the power supply of the drive box 3 is turned OFF.

The electric power control program 143 instructs, via the management I/F 117, the PDU 41 to stop the supply of electric power to the drive box 3. In the configuration example of FIG. 1, different controller packages 110 for example instruct the corresponding PDUs 41 to stop the supply of electric power to the drive box 3. The PDU 41 stops the supply of electric power to the drive box 3. The electric power control program 143 in the drive box management table 148 changes the value of the drive box status column 484 of the drive box 3 from “controller power saving” to “power supply OFF”.

When all of storage drives 2 of one parity group are stored in one drive box 3, the control of the parity group is shifted to the power saving layer T3 and subsequently the control of the drive box 3 is shifted to the power saving layer T4. When the drive box 3 stores only a part of the storage drives 2 of a specific parity group and when the control of the parity group exists in the power saving layer T1 or T2, then the control of the drive box 3 may be shifted to the power saving layer T4.

For example, it is assumed that the storage drive 2 stored in the drive box 3 is configured by the redundant drives of two parity groups. When the control of these parity groups exists in the power saving layer T1, then the power supplies of all of the storage drives 2 stored in the drive box 3 are OFF.

As described above, it is assumed that the power consumption control of the parity group proceeds, in a stepwise manner, to the no-power-saving layer TN, the power saving layer T1, the power saving layer T2, and the power saving layer T3 in this order depending on the elapsed time since the stoppage of the host I/O. The host I/O referred to as a condition for the layer shift is, for example, a write access for the shift from the no-power-saving layer TN to the power saving layer T1 and a write access and a read access for the shift from the power saving layer T2 to the power saving layer T3. A change of the drive box 3 to the power saving status requires a condition that the power supplies of all of the storage drives 2 stored therein are OFF. The power consumption control of the drive box 3 similarly proceeds, depending on the elapsed time since the stoppage of the host I/O, to the no-power-saving layer TN, the power saving layer T4, and the power saving layer T5 in this order in a stepwise manner.

The following section will describe the processing for the I/O request (a write request or a read request) from the host server 100. First, the following section will describe the processing of a write request from the host server 100. In the example described below, upon receiving a write request to the parity group including the storage drive 2 that is not in the normal status, the storage controller 11 causes all of the storage drives 2 of the parity group to change to the normal status. The access control program 142 receives the write request and the write data from the host server 100 via the host I/F111. The write data is temporarily stored in the memory 114.

The access control program 142 refers to the drive management table 145 and the drive box management table 148 to confirm the to-be-accessed parity group and the status(es) of one or a plurality of the drive box(es) 3 storing the parity group. When the drive box status column 484 shows that the power supply of the drive box 3 is OFF, the access control program 142 instructs the electric power control program 143 to turn ON the power supply of the drive box 3.

FIG. 8 is a flowchart illustrating the processing to turn ON the power supply of the drive box 3. The electric power control program 143 instructs, via the management I/F 117, the PDU 41 for supplying electric power to the drive box 3 to start the supply of electric power to the drive box 3 (S201). When the drive box 3 receives supplied electric power, the drive box controller 31 operates to turn ON the power supplies of all of the storage drives 2 in the drive box 3.

When the electric power control program 143 receives a response from the drive box controller 31 that the power supplies are turned ON, the electric power control program 143 instructs a spin-up operation to the HDDs stored in the drive box controller 31 (S203). When no HDD is stored in the drive box 3, this step is omitted.

In Step S203, the electric power control program 143 specifies the C/R# of the storage drive (HDD) 2 via the drive I/F 113 to send, to the expander 32 (drive box controller 31), a command to instruct a spin-up operation. The expander 32 sends the command instructing a spin-up operation to the specified storage drive (HDD) 2. Based on the command, the storage drive (HDD) 2 starts the rotation of the magnetic disk. The electric power control program 143 updates the drive management table 145 and the drive box management table 148.

The access control program 142 receives a response from the electric power control program 143 that the drive box 3 and the power supply of the storage drive 2 as a target are turned ON and are in the normal status. After all of the storage drives 2 of the target parity group are turned to the normal status, the access control program 142 executes the write processing to the target parity group. The access control program 142 writes new write data to the storage drive 2 and updates the parity data.

In order to write data to the storage drive 2, the access control program 142 sends the write request and the write data via the drive IF 113 and through the expander 32. The write request shows the identifier (e.g., C/R#) of the storage drive 2 as a target. The expander 32 sends the write request and the write data to the specified storage drive 2 and returns the response from the storage drive 2 to the drive I/F 113 from which the request was sent. The drive I/F 113 returns the received response to the access control program 142. When the drive box status column 484 shows that the drive box controller 31 of the drive box 3 as a target is in the power saving status, the access control program 142 instructs the electric power control program 143 so as to cancel the power saving status of the drive box controller 31 to change the drive box controller 31 to the normal status.

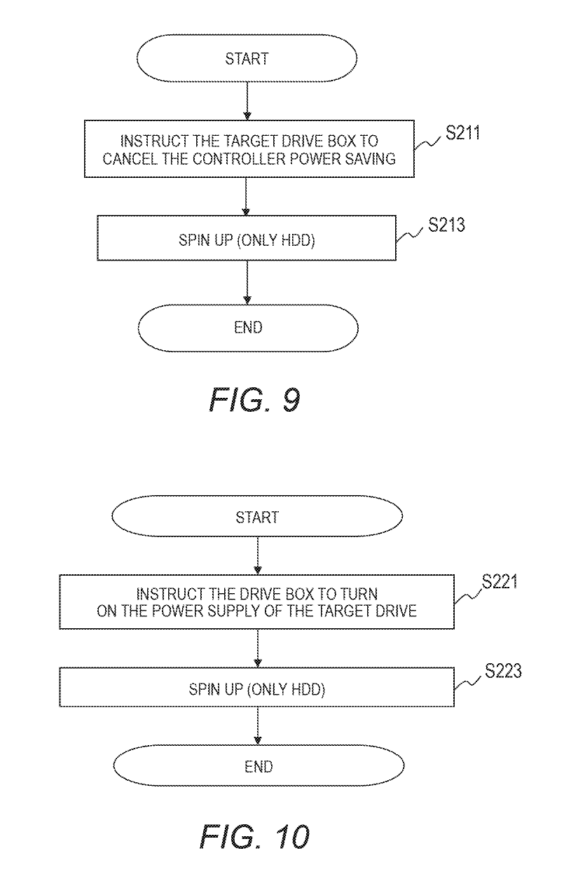

FIG. 9 is a flowchart of the processing to return the drive box controller 31 in the power saving status to the normal status. The electric power control program 143 instructs, via the management I/F 117, the drive box controller 31 of the target the drive box 3 to cancel the controller power saving (S211).

Upon receiving the instruction, the drive box controller 31 returns to the normal status from the power saving status. The drive box controller 31 turns ON the power saving status of all of the storage drives 2 in the drive box 3. The electric power control program 143 updates the drive management table 145 and the drive box management table 148. The access control program 142 receives a response from the electric power control program 143 that the drive box controller 31 and the storage drive 2 of the drive box 3 as a target are in the normal status. After all of the storage drives 2 of the target parity group are set to the normal status, the access control program 142 executes a write processing to the target parity group.

When all of the drive boxes 3 storing therein the target parity group are in the normal status and one or all of the storage drive(s) 2 in the parity group is/are not in the normal status, the access control program 142 instructs the electric power control program 143 to cause the respective storage drives 2 not being in the normal status to return to the normal status. In this example, statuses other than the normal status include a power supply OFF status, a spin down status (HDD), or a core save status (SSD). The access control program 142 refers to the drive status column 454 and the save rank column 460 of the drive management table 145 to identify the statuses of the respective storage drives 2.

FIG. 10 is a flowchart to return the storage drive 2 in the power supply OFF status to the normal status. The electric power control program 143 instructs, via the management I/F 117, the drive box controller 31 (the drive box 3) to turn ON the power supply of the specified storage drive 2 (S221). The drive box controller 31 turns ON the power supply of the specified storage drive 2 to subsequently returns a response to the electric power control program 143.

When the storage drive 2 for which the power supply is ON is an HDD, the electric power control program 143 instructs the storage drive 2 to perform a spin-up operation (S223). Based on the instruction, the storage drive (HDD) 2 starts the rotation of the magnetic disk. When the storage drive 2 is an SSD, this step is omitted. The electric power control program 143 updates the drive management table 145 to return a response of the completion to the access control program 142.

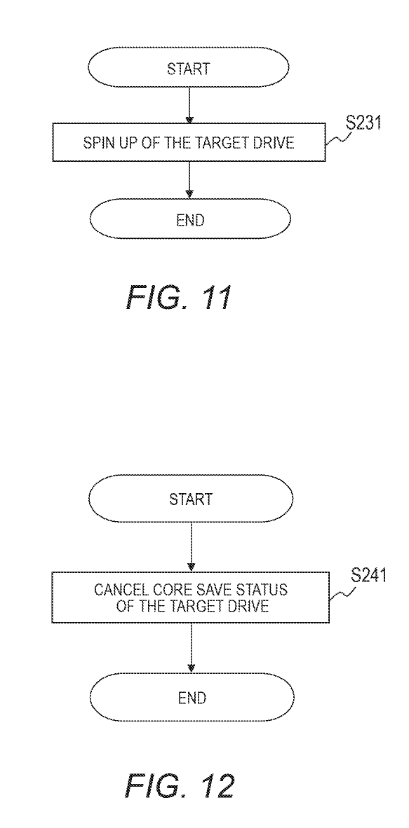

FIG. 11 is a flowchart of the processing to return the HDD in the spin down status to the normal status. The electric power control program 143 instructs the storage drive (HDD) 2 to perform a spin-up operation (S231). Based on the instruction, the storage drive (HDD) 2 starts the rotation of the magnetic disk. The electric power control program 143 updates the drive management table 145 and returns a response of the completion to the access control program 142.

FIG. 12 is a flowchart of the processing to return the SSD having the core save status to the normal status. The drive status column 454 having the SSD in the core save status shows the “core save”. The save rank column 460 shows any of the rank 2 to the rank 4. The electric power control program 143 instructs the storage drive (SSD) 2 to change from the core save status to the normal status (S241). Based on the instruction, the storage drive (SSD) 2 changes to the normal status. The electric power control program 143 updates the drive management table 145 and returns a response of the completion to the access control program 142.

When the save rank of the storage drive 2 is the rank 1, the electric power control program 143 changes the value of the drive status column 454 to “normal” without sending an instruction to the storage drive 2 and changes the value of the save rank column 460 to NULL and returns a response of the completion to the access control program 142. Next, the following section will describe the processing of a read request from the host server 100. When the storage drive (target storage drive) 2 storing therein the target data of the read request is in the normal status or in the core save status, the access control program 142 reads target data from the storage drive 2.

In order to read data from the storage drive 2, the access control program 142 sends a read request to the expander 32 via a drive IF 113. The read request shows the identifier of the storage drive 2 as a target. The expander 32 sends the read request to the specified storage drive 2 to return a response from the read data from the storage drive 2 to the drive I/F 113 from which the request was sent. The drive I/F 113 returns the received response to the access control program 142.

When the power supply of the target storage drive 2 is OFF and a part of the storage drives 2 of the parity group is in the normal status or the core save status (the power saving layer T1 or the power saving layer T2 of the SSD), the access control program 142 restores target data from the data (including parity data) stored in the storage drive 2 of the parity group having the normal status or the core save status.

When the parity group of the target storage drive 2 includes the storage drive 2 in the spin down status, the access control program 142 causes all of the storage drives 2 of the parity group to change to the normal status. Thereafter, the access control program 142 reads the target data from the storage drive 2. As has been described with reference to FIG. 11, the access control program 142 causes the storage drive 2 to change from the spin down status to the normal status. As has been described with reference to FIGS. 8 to 10, the access control program 142 causes the storage drive 2 to change from the power supply OFF status to the normal status.

When the power supplies of all of the storage drives 2 of the parity group of the target storage drive 2 are OFF, then the access control program 142 causes all of the storage drives 2 of the parity group to change to the normal status. Thereafter, the access control program 142 reads the target data from the storage drive 2. As has been described with reference to FIGS. 8 to 10, the access control program 142 causes the storage drives 2 to change from the power supply OFF status to the normal status.

Another configuration may be used in which only the power saving layer partially constituting the electric power consumption layer structure (e.g., only the power saving layer T2 of the SSD parity group) is provided. For example, when no write access (or write request) exists over the time equal to or longer than the specified time, the storage controller 11 may cause, in response to the instruction from the management computer 150, the control of the parity group of SSD to shift from the no-power-saving layer TN to the power saving layer T2. When none of the write and read I/Os exists for the time equal to or longer than the specified time, the storage controller 11 may cause the control of the parity group of the SSD to shift from the no-power-saving layer TN to the power saving layer T2. The types of the I/Os referred to in order to switch the SSD status in the power saving layer T2 may be both of the read and write I/Os. The storage controller 11 may return, in response to the instruction from the management computer 150, to the no-power-saving layer TN from the power saving layer T2.

When the power saving layer T1 is omitted, the storage controller 11 may execute the layer control not on the parity group but on each storage drive. When the power saving layer T2 of the parity group of the HDD receives a read access, the storage controller 11 may cause all drives of the parity group to change to the normal status and may cause only the storage drive to which the read access was provided to change to the normal status. When the parity group in which all storage drives have OFF power supplies receives a read request, the storage controller 11 may cause all drives of the parity group to change to the normal status and may cause only the storage drive to which the read access was provided to change to the normal status.

The storage controller 11 may be configured, depending on the instruction from the management computer 150, to cause the storage drive 2 and the drive box 3 to recover to the normal status from the power saving status (including power supply OFF). For example, when the drive box 3 and the power supply of the storage drive 2 stored therein are OFF (power saving layer T5), the storage controller 11 receives a recovery instruction specifying the drive box 3 or the parity group from the management computer 150. As has been described with reference to FIG. 8, the storage controller 11 causes the drive box 3 and the storage drive 2 to change to the normal status.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card. The drawings shows control lines and information lines as considered necessary for explanations but do not show all control lines or information lines in the products. It can be considered that almost of all components are actually interconnected.

What is claimed is:

1. A storage system, comprising:
one or more storage drives; and
a controller for controlling the one or more storage drives,
wherein, each of the one or more storage drives has a plurality of power consumption statuses,
wherein, the plurality of power consumption statuses can respond to a read request and a write request, and have different power consumptions and different response performances, and
wherein, the controller is configured:
to monitor frequencies of predetermined types of I/Os to each of the one or more storage drives; and
to set, based on the frequencies, each of the one or more storage drives to a status selected from the plurality of power consumption statuses.

2. The storage system according to claim 1, wherein the controller is configured:
to control the one or more storage drives in a plurality of electric power control layers having different power saving effects of the one or more storage drives;
to cause, depending on the elapsed time from a predetermined type of last I/O request to the one or more storage drives, a shift from the current electric power control layer to an electric power control layer having a higher power saving effect; and
to set, in a first electric power control layer in the plurality of electric power control layers, the one or more storage drives to a status selected from among the plurality of power consumption statuses, respectively, based on the frequencies.

3. The storage system according to claim 2, wherein the controller is configured:
to shift to the first electric power control layer to subsequently shift to a second electric power control layer, and
to turn OFF all of the power supplies of the one or more storage drives in the second electric power control layer.

4. The storage system according to claim 2,
wherein the one or more storage drives are a plurality of storage drives,
wherein the plurality of storage drives constitutes a redundancy group to store host data and redundant data in a dispersed manner, and
wherein the controller is configured:
to shift to a third electric power control layer to subsequently shift to the first electric power control layer; and
to select, in the third electric power control layer, a storage drive from the plurality of storage drives at a maximum number equal to or lower than the redundancy of the redundancy group to turn OFF the power supply.

5. The storage system according to claim 4, wherein the controller is configured to shift to the third electric power control layer when the plurality of storage drives are in a normal status and a specified time has passed since a last write request to the plurality of storage drives.

6. The storage system according to claim 4, wherein when a first storage drive for which the redundancy group has an OFF power supply receives, in the third electric power control layer, a read request, then the controller restores target data of the read request based on data read from a storage drive other than the first storage drive of the redundancy group.

7. The storage system according to claim 3, wherein the controller is configured, when a specified time has passed since a last request among a write request and a read request to the one or more storage drives, to shift from the first electric power control layer to the second electric power control layer.

8. The storage system according to claim 3,
wherein the storage system further includes a drive box to store at least a part of the one or more storage drives, and
wherein the controller is configured, when the power supplies of all of the storage drives stored in the drive box are OFF, to change the drive box from a normal status to a power saving status.

9. The storage system according to claim 8, wherein the controller is configured, when the drive box is in a power saving status, to temporarily stop a drive box controller provided in the drive box.

10. The storage system according to claim 9, wherein the controller turns OFF the power supply of the drive box when a read request and a write request to the storage drives stored in the drive box do not exist for the time equal to or longer than a specified time since the drive box is changed to the power saving status.

11. The storage system according to claim 4,
wherein the storage system further includes a drive box to store at least a part of the one or more storage drives, and
wherein the controller is configured, when the power supplies of all of the storage drives stored in the drive box are OFF, to change the drive box from a normal status to a power saving status.

12. A method of controlling a storage system including one or more storage drives,
wherein each of the one or more storage drives has a plurality of power consumption statuses, and
wherein the plurality of power consumption statuses can respond to a read request and a write request, and have different power consumptions and different response performances,
the method comprising:
monitoring frequencies of predetermined types of I/Os to the one or more storage drives, and
setting, based on the frequencies, each of the one or more storage drives to a status selected from the plurality of power consumption statuses.
